(19) United States
(12) Patent Application Publication
(10) Pub. No.: US 2005/0010448 A1
(43) Pub. Date: Jan. 13, 2005

(54) Methods for dispensing prescriptions and collecting data related thereto

(76) Inventor: John A. Mattera, Boca Raton, FL (US)

Correspondence Address: John A. Mattera, 18763 Long Lake Drive, Boca Raton, FL, 33496, US

(21) Appl. No.: 10/614,651

(22) Filed: Jul. 7, 2003

(51) Int. Cl. G06F 17/60

(52) U.S. Cl. 705/3; 705/2

(57) ABSTRACT

Methods for generating and maintaining confidential medical information, and in particular electronic medical records, that are operative to both preserve the secrecy and confidentiality of such information, but further enables medical information to be generated for purposes of research, public health, or healthcare operations. According to a preferred embodiment, confidential medical information is input into a conventional electronic medical records system and maintained in a first format, but is further converted to a second format whereby such information is purged of all patient information and identifiers. Such de-identified data is compiled on a routine basis, such as a daily basis, and forwarded to an entity certified to receive such information pursuant to a research or data use agreement. The invention further comprises methods for providing a prescription benefit via the distribution of prescription medications through mail order wherein such medications are procured from either a domestic or foreign source depending upon cost of the prescription medications.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The Health Insurance Portability and Accountability Act (HIPAA) of 1996, signed into law on Aug. 21, 1996, sets forth numerous regulations related to the practice of medicine, particularly with respect to the handling of healthcare-related information, that are intended to reduce the administrative costs of healthcare. Essentially, HIPAA sets forth provisions related to the development and implementation of standardized electronic transactions and the implementation of privacy and security procedures to insure confidentiality and prevent the misuse of patient information. With respect to the former, namely, standardized transactions, the same are to be used no later than Oct. 16, 2003, whereas the privacy requirements were to have been implemented by Apr. 14, 2003.

Among the many requirements set forth in HIPAA is that any medical practice that electronically sends or receives certain transactions must send and receive them in a standard format. Such transactions expressly include claims, remittance and payment advice, claims status, enrollment and dis-enrollment in a health plan, premium payments, eligibility inquiries and responses, referral certifications and authorization, coordination of benefits, first reports of injury, and claims attachments. In this regard, it is contemplated that a medical practice will be able to submit a claim for a patient, irrespective of the payor involved (e.g., insurance company, health maintenance organization, etc.). As a result, it is contemplated that all transactions will be standardized in nature, which will include the uniform use of codes typically associated with conventional billing practices, such as diagnosis codes (i.e., ICD-9-CM), procedure/service codes (CPT-4), drug codes (NDC), and other service codes (HCPCS), among others.

Despite its intentions, substantial difficulty has been encountered in numerous medical practices regarding implementation of HIPAA regulations. Specifically, the deployment of online healthcare transactions raises substantial concerns regarding patient privacy and content security insofar as HIPAA requires all individually-identifiable healthcare information be protected to ensure privacy and confidentiality when electronically stored, maintained, or transmitted. Particularly vulnerable are electronic transactions transmitted via the Internet, such as through e-mail, which is well-known in the art to be prone to security breaches, information interception, and potentially devastating liabilities.

In response to such regulations, numerous attempts have been made to develop software, and in particular software for generating electronic medical records (EMR), electronic claims filing, and other medical management tasks (e.g., managed care and capitation tracking, referral analysis reports, etc.) that help ensure compliance with HIPAA regulations. Exemplary of such software include EMR, electronic claims filing, medical billing and medical management software products produced by American Medical Software of Edwardsville, Ill.; Smart Doctor EMR, a billing software produced by Intelligent Medical Systems, Inc., of Alpine, Tex.; SOAPware EMR software, produced by Docs, Inc., of Springdale, Ariz.; and EMR, medical billing and practice management software produced by Expert System Applications, Inc. of Solon, Ohio. Generally, such automated, software-driven products are operative to facilitate and increase the efficiency of conventional healthcare practices, substantially enhance the security associated with patient information, and utilize all applicable standard formats necessary to conduct and codify electronic transactions.

In contrast to the interests of privacy and security related to medical information that are sought to be furthered by the regulations implemented by HIPAA is the need for collecting information useful for research. Specifically, information related to a specific medical practice, hospital, or type of care provided in a general area is extremely useful in predicting trends and anticipating future healthcare needs. In this regard, information related to hospital admissions, type and nature of medical procedures or services rendered by a specific medical practitioner or medical group, type and volume of prescription medications that are prescribed by a specific physician or medical group, and information related generally to the diagnosis and clinical evaluation made by a practitioner or medical group are extremely useful in assessing the epidemiology and etiology of a specific disease or an abnormal condition. Furthermore, such information is extremely useful as marketing data which can be utilized to determine the practice characteristics of a specific practitioner or health group. Exemplary of the latter includes prescribing habits, particularly with respect to volume and types of medication prescribed by a given practitioner, which is extremely useful as marketing data for determining sales effectiveness, market share, and trends in medical management practices.

Due to the restrictions imposed by HIPAA, particularly with respect to the obligation placed on healthcare providers to ensure privacy and security of patient information, the use of patient data, particularly as is stored and handled utilizing EMR and other software applications, it is extremely difficult and counterintuitive to the objectives sought to be obtained via the HIPAA legislation. While the HIPAA legislation does allow, to a very limited extent, the use of confidential information, such information must undergo strict editing or de-identification. In this regard, there is no requirement for a practice or medical group to de-identify confidential information and a practice can choose to implement a policy simply stating that it does not de-identify data. However, to the extent a given medical practice, group or other healthcare provider that is obligated to comply with HIPAA decides to develop a policy on the de-identification of information such healthcare provider must develop a policy on the de-identification of information that ensures that a patient or other individual whose confidential information must be kept private and secure is not identified or if the healthcare provider has no actual knowledge that can be used to identify the patient/individual to which the confidential information applies.

To achieve that end, healthcare providers obligated to comply with HIPAA must either have an assessment made by a person with appropriate knowledge and expertise that certifies that the confidential information in question is sufficiently de-identified or that the healthcare provider remove virtually all possible identifiers that can be utilized to identify a particular patient/individual to which the confidentiality obligation applies. With respect to the latter, such de-identification procedure must remove several specific types of information, including the name of the patient/individual, all pertinent telephone numbers, fax numbers, electronic mail addresses, Social Security numbers, medical record numbers, health plan beneficiary numbers, all geographic subdivisions smaller than a state (including street address, city, county, precinct, ZIP Codes) all elements of dates (except year) for dates directly related to the patient/individual (including birth date, hospital admission date, discharge date, date of death), and any other unique identifying number, characteristic or code, including full face photographic images and any comparable images.

In a further limited context, HIPAA allows healthcare providers obligated to comply with HIPAA to disclose a limited data set for the purposes of research, public health, or public care operations. Similar to the procedures set forth with respect to the de-identification of data, to the extent a healthcare provider obligated to comply with HIPAA decides to develop a policy on the provision of limited data sets, such healthcare provider must follow strict procedural guidelines, and in particular, must generate such limited data sets such that the same exclude a significant amount of confidential information. Specifically, such limited data sets must exclude numerous direct identifiers of the patient or of the relatives, employers, or household members of the patient, which include among other things the patient's name, postal address information, telephone numbers, fax numbers, electronic mail addresses, Social Security numbers, medical record numbers, health plan beneficiary numbers, vehicle identifiers and serial numbers (including license plate numbers), and biometric identifiers, including finger and voice prints as well as full face photographic images and any comparable images. Moreover, even to the extent such limited data set is generated which excludes such direct identifiers, the healthcare provider seeking to utilize such limited data set must enter into a “date use agreement” with the recipient of the limited data set. Such agreement is required to establish the permitted uses and disclosures of the limited data set by the recipient, who is permitted to use or receive the limited data set, and that the limited data set will remain confidential. Along these lines, HIPAA expressly requires that the healthcare provider make reasonable efforts not to use or disclose more than the minimum amount of confidential information necessary to accomplish the intended purpose of the use, disclosure, or request taking into consideration practical and technological limitations.

In light of the substantial restrictions imposed by HIPAA, healthcare providers obligated to comply with HIPAA are strongly discouraged from compiling any type of data that may be deemed useful for the purposes discussed above with respect to research, marketing, and the like. Indeed, HIPAA imposes stiff penalties for healthcare providers failing to comply with the regulations set forth in such legislation, which include hefty fines, particularly for repeat offenders. Indeed, any attempt to compile data utilizing conventional EMR software products, or any other medical management software for that matter, typically makes generating any type of data that is either de-identified or part of a limited data set, exceedingly difficult if not impossible insofar as the same must be specifically engineered to ensure compliance with HIPAA regulations. Accordingly, there is a substantial need in the art for a method that can not only ensure compliance with HIPAA with respect to preserving the confidentiality and security associated with patient information, but can further generate data in compliance with HIPAA and can be utilized for the purposes of research, public health or healthcare operations. There is additionally a need in the art for such a method that can be readily implemented and can serve as a revenue-generating model that attains HIPAA compliance but also creates data that can be utilized for other purposes.

In addition to the need to serve both the competing needs of HIPAA legislation and the need for raw medical data to be used for research and marketing purposes is the further need to integrate as part of such system a prescription benefit program that can advantageously be utilized by healthcare providers obligated to comply with HIPAA, with a means to fill their patients' prescriptions at a substantially lower cost than traditional methods by which prescriptions are typically filled. Generally, prescription drugs are distributed through five primary categories, namely, traditional chain drug stores, independent drug stores, mail order, supermarket/grocery stores, and mass merchants. Presently, the prescription drug generates sales of approximately 200 billion dollars a year in the United States alone.

With respect to such categories, mail order prescription sales are the newest segment, presently accounting for over 25 billion dollars in annual sales, and is recognized as the fastest growing channel through which pharmaceuticals are distributed. In this regard, mail order distribution of pharmaceuticals is particularly well suited for those suffering from chronic afflictions which are presently believed to affect over 100 million consumers in the United States alone. Advantageously, the distribution of pharmaceuticals by mail enables prescription medications that must be taken repetitiously for an indefinite period to be routinely delivered which thus eliminates the need of a patient to make separate trips to a pharmacy. Such scenario can be particularly problematic if such patient is an elderly person or is non-ambulatory. Likewise, due to the low overhead costs associated with mail order prescription delivery, the prices associated with distributing prescription medications through the mail is deemed highly advantageous.

Notwithstanding the advantages associated with mail order pharmaceutical distribution, significant drawbacks still exist due to the pricing structure utilized by pharmaceutical companies to price prescription drugs for sale in the United States. Generally, pharmaceutical companies set pharmaceutical prices according to levels of demand, government price regulations or restrictions, relative currency value of a particular country, and the ability of the patient population to pay within a given country. Such factors, particularly with respect to the latter, when viewed from the perspective of the United States marketplace have resulted in pharmaceutical prices to be among the highest in the world. As has been extensively reported, identical prescription medications procured outside of the United States, and in particular Canada and Mexico, can cost between 30% to 80% less than the identical prescription medications sold in the United States. Ironically, the price charged for such medications is substantially less despite the fact that such pharmaceuticals are manufactured by the same manufacturer as medications sold in the United States, have the same formulation, and provide the identical therapeutic benefit.

Unfortunately, however, to the extent patients wish to take advantage of such lower pricing typically requires travel across the borders of the United States in order to procure such lower-priced pharmaceuticals. Such options are not feasible to the extent a patient does not live in close proximity to a foreign border (i.e., Mexico or Canada) or is unable or does not desire to go to such efforts to procure such lower priced medication. While legislation has previously been enacted during the Clinton administration which allows for the importation of pharmaceuticals from outside the United States, there has not heretofore been any implementation of any type of prescription program operative to distribute pharmaceutical medications that have been procured in foreign markets that enable such medications to be procured at substantially lower prices. There has much less been any type of coordinated drug benefit that enable such lower cost pharmaceuticals to be procured and distributed from such foreign markets that, as discussed above, can do so in a manner that enables such lower-cost pharmaceuticals to be distributed that does not otherwise compromise the confidentiality and security of patient information.

Accordingly, there is yet a further need in the art to provide a pharmaceutical distribution system and method that, in addition to complying with all applicable regulations, enables prescription medications to be procured from a foreign source, such that such medications can be procured at substantially lower prices (as compared to equivalent pharmaceuticals procured within the United States) but yet can be distributed to patients residing within the U.S. to thus enable such patients to enjoy cost savings associated with such lower priced medications. There is additionally a need in the art for a method for distributing pharmaceuticals that can also be utilized to generate data related to research, public health or healthcare operations, as well as other possible uses such as prescribing habits and other pharmaceutical marketing information that enables prescriptions to be filled at a substantially lower cost while also generating such information in a manner that complies with all aspects of HIPAA regulation. There is still further a need for such a distribution system and method that is of low cost to implement, can be readily utilized using existing software in pharmaceutical distribution practices, can be readily integrated into virtually every type of medical practice, pharmacy or prescription-related business involving healthcare providers having to comply with HIPAA, and can be utilized as a revenue-generating model operative to generate revenue.

### BRIEF SUMMARY OF THE INVENTION

The present invention specifically addresses and alleviates the above-identified deficiencies in the art. In this regard, the present invention is directed to methods for generating and maintaining confidential patient information such that the same complies with all regulations associated with HIPAA, but is further operative to generate de-identified information or limited sets that are useful for research purposes. According to a preferred embodiment, the method comprises the initial step of compiling medical information, which is derived through conventional methods via the interaction between one or more patients and a healthcare provider. Preferably, the information is input into an electronic medical record (EMR) data base, the latter of which may be licensed to the healthcare provider via a separate software license. The healthcare provider responsible for generating and inputting such confidential data through such EMR system will enter into a separate agreement with a research entity that, in compliance with HIPAA, will designate a recipient designated to receive de-identified data derived from the medical information input into the EMR. Once the information is input into the EMR, the same may be stored, retrieved, and updated as per conventional EMR practice and preferably in accordance with all applicable electronic formats. Such data is further separately edited such that the same is ultimately altered into a second state whereby such information undergoes the de-identification necessary for such data to be utilized for research purposes pursuant to the regulations of HIPAA. In this regard, such medical information, will be selectively edited such that all personal information related to the patients referenced therein, including any and all identifiers related to each patient, such as Social Security number, phone number, insurance information, and the like, are completely removed. Once such information is generated such that the same has been sufficiently de-identified pursuant to HIPAA, the same is then forwarded to the recipient set forth in the research agreement. Preferably, medical data is collected, de-identified and forwarded to the authorized recipient on a routine basis, which may preferably be either daily or weekly.

In addition to (or separate from) the methods for generating HIPAA-compliant medical information, the present invention further comprises methods for distributing pharmaceuticals which incorporates the use of medications procured from a source foreign to the United States. According to such method, a patient is evaluated, per conventional medical practice, and a determination is made by the healthcare provider as to whether or not the patient is in need of a prescription medication. To the extent a prescription is warranted, the same is forwarded to a prescription filling entity that evaluates the prescription to determine whether or not the same is objectively reasonable in view of conventional medical standards (i.e., to review for drug interactions, adverse reactions, contraindications, and the like). Additionally, such prescription is evaluated to determine from what source such medication can be most inexpensively obtained. In making such decision, it is expressly contemplated that consideration will be made as to whether the medication can be procured more cost effectively from either a domestic source within the United States, or from a source foreign to the United States. To the extent the domestic source is most const-effective, the prescription is filled utilizing the domestically procured medication. Alternatively, to the extent the foreign source of medication is less expensive, the medication is procured from such foreign source and ultimately distributed to the patient. In order to enable such medication procured from such foreign source to be imported into the country, all applicable regulations will be strictly adhered to, including advising such foreign source that such medication is being prescribed by a particular physician, providing such prescribing physician's contact information, as well as including any applicable statements certifying that the medication sought to be procured is for the patient's personal use. Preferably, such medications will be distributed via mail, although it is contemplated that any conventional marketing channel utilized to distribute pharmaceuticals may be utilized.

### BRIEF DESCRIPTION OF THE DRAWINGS

These as well as other features of the present invention will become more apparent upon reference to the drawings.

FIG. 1 is a flow chart depicting steps for generating and managing patient data such that said data is maintained in a first secure and confidential state and a second de-identified state.

FIG. 2 is a flow chart depicting the steps for providing the distribution of pharmaceuticals to patients wherein such pharmaceuticals are procured from either a domestic or a foreign source, as determined by pharmaceutical cost.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

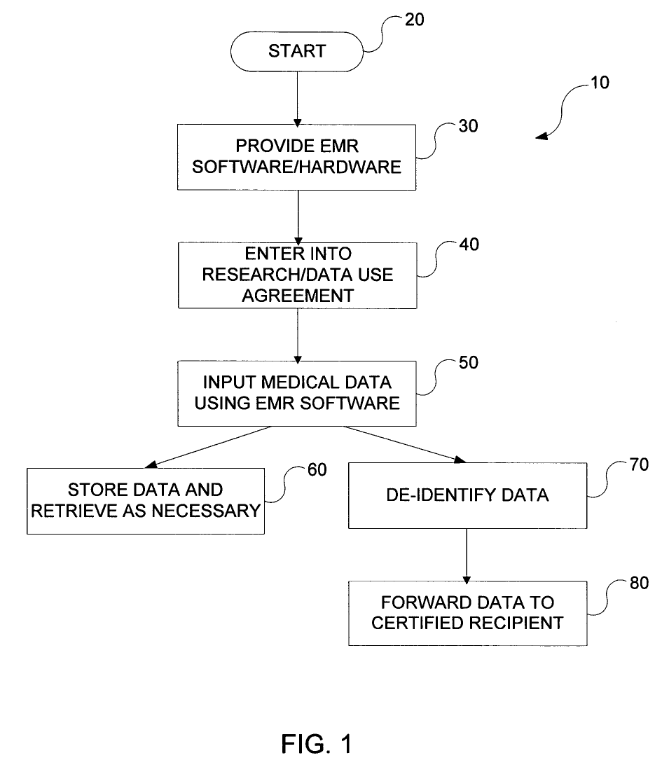

Referring now to the figures, and initially to FIG. 1, there is shown the steps for practicing the present invention that are useful in preserving the confidentiality and secrecy of confidential medical information, as required by HIPAA regulations, but are also effective in generating data useful for research and marketing purposes that likewise complies with all aspects of HIPPA. Initially, such process 10 starts 20 by means of a healthcare provider in connection with the practice of medicine, and in particular the conventional procedures followed between physician and patient with respect to the care of a particular patient. Along these lines, it is contemplated that the present invention will be utilized exclusively by healthcare providers, which includes physicians, hospitals, medical groups, healthcare plans, health maintenance organizations, or any entity that is under an obligation to comply with regulations related to HIPAA and are responsible for generating confidential medical information or who otherwise have access to such information. Accordingly, for purposes of the present invention, the term healthcare provider will expressly encompass any individual or entity responsible for generating confidential medical information regarding a particular patient or patient population, as well as any individual or entity entrusted to comply with the obligations of HIPAA regulations, particularly with respect to ensuring that confidential patient information is kept secure and private. With respect to such confidential information, for purposes of the present application it should further be understood that such information is meant to encompass any and all information deemed to be confidential or that otherwise places an obligation on a healthcare provider to maintain the security and privacy of such information, as expressly set forth in HIPAA. Accordingly, the term confidential information should be construed as broadly as such legislation permits.

Within such conventional framework, namely, whereby healthcare providers render care and other medical services to patients, there will first be provided conventional EMR software and, optionally, hardware to thus provide the means by which a healthcare provider will input medical information or other data related to specific patients. Along these lines, it is contemplated that such EMR software/hardware may utilize existing software technology, and in particular those specific software products referenced in the Background, that allow for conventional input of patient information according to a standard electronic format. To that end, it is contemplated that the EMR software will, as per a variety of commercially available software products, allow for the input of comprehensive patient information and is all known features in the art, such as patient follow-up reminders, patient progress reports, a detailed history of the patient's medical background plus other features well-known to those skilled in the art. One particularly well-suited software program presently available include the Dr. Notes ™ program—clinical management and disease prevention software with an interface MediCare coder and practice management/electronic billing system produced by Dr. Notes, Inc. of Boca Raton, Fla. Such product provides an extremely comprehensive EMR system plus provides other features that enable healthcare providers to comprehensively input all data necessary to comprehensively assess the health of a patient.

With respect to the EMR software/hardware which may be utilized in step 30, it is further contemplated that the same may be provided pursuant to a separate software/hardware license. Such optional license of the software/hardware may, according to conventional practices well-known in the art, serve as a basis for generating revenue, such as through the licensing of software, etc. Alternatively, such EMR software/hardware provided in step 30 may be offered in connection with other incentives or other contractual arrangements, especially in connection with other licenses or agreements related to the collection of de-identified date and/or participation by the healthcare provider in a prescription benefit program.

With respect to the former, namely, a research/data use agreement entered into between the health care provider and a research entity, the same is integrated as part of such process 10 via step 40. As discussed more fully below, in order to properly utilize medical information outside of its use with respect to patient care, which otherwise must be maintained in a secure and confidential manner, current HIPAA regulations require that a research and data use agreement be in place in order for certain medical information that has been extensively and selectively edited to be utilized for purposes of research, public health, or healthcare operations. Accordingly, the present invention expressly contemplates that such research/data use agreements will be in place to thus enable the present invention to be practiced such that the same complies with HIPAA regulations in all respects.

Once the EMR infrastructure is established, coupled with the existence of a research/data use agreement, a healthcare provider may provide healthcare to patients and input any and all applicable medical information related thereto utilizing the EMR software in step 50. Along these lines, it is contemplated that all conventional healthcare procedures utilizing conventional EMR practices may be utilized in the performance of step 50. Along these lines, it is contemplated that medical histories, procedure and diagnosis codes, billing information, prescription information and all other pertinent information will be included within step 50. Advantageously, it is expressly contemplated that the EMR software utilized will place all such information in the standard electronic format required by HIPAA to thus enable the information to be properly utilized for electronic transactions, as expressly mandated by such legislation.

To that end, it is contemplated that once the medical date using the EMR software has been sufficiently input for purposes of generating files and other compilations of data, the same can be stored and retrieved as is necessary in step 60. In this regard, it is contemplated that such medical data can be utilized for ongoing patient evaluation, as well as all other aspects of medical practice management. For example, it is contemplated that the data may be stored and retrieved as necessary in step 60 in order to conduct all transactions necessary to related to billing procedures. It is further contemplated that such medical data can be utilized in transactions related to filling prescriptions, discussed below with respect to another aspect of the present invention, or any other transaction related to the healthcare provided to a patient as expressly set forth in applicable HIPAA regulations, such as enrollment and disenrollment in a health plan, eligibility inquiries and responses thereto, referral certifications and authorizations and the like.

With respect to the medical data that is input in step 50, the same is further extremely useful for purposes of research, public health, or healthcare operations, as discussed above. In order to utilize the medical data input in step 50 for such purposes, however, which will only be utilized for those express purposes allowed by HIPAA and set forth in the research/data use agreement provided in step 40, the same will be sufficiently de-identified as required pursuant to all applicable HIPAA regulations. In this regard, it is contemplated that the medical data input in step 50 will be stored in step 60 in a first unedited format whereby all applicable confidential information is kept in tact and can be readily accessed by healthcare providers to thus enable such providers to have access to completely privileged, comprehensive and uncensored patient information. As will be readily appreciated, such information will include any and all applicable personal information about the patient, including any and all applicable identifiers associated with such patient, such as names, postal address information, telephone numbers, Social Security numbers, medical records/health plan beneficiary numbers, as well as any and all other relevant information pertinent to the specific patient.

In step 70, in contrast, the medical data stored in step 50 will undergo substantial editing such that the data becomes de-identified. Along these lines, it is contemplated that such de-identified data will strictly adhere to all applicable de-identification provisions set forth in any and all applicable HIPAA regulations, and thus will eliminate any and all personal information and identifiers related to the data collected in relation the patients being treated. Moreover, it is further expressly contemplated that such de-identification of data step 70 will sufficiently remove such personal information and direct identifiers of such patient or patients to thus enable such data to be compiled as part of a limited data set, as defined by HIPAA. In this regard, it is expressly contemplated that such limited data sets may be readily generated by excluding all direct identifiers of the patient or of the relatives, employers, or household members of a patient as expressly set forth in the HIPAA regulations. Currently, such limited data set, similar to the information that must be removed to sufficiently de-identify patient data, must exclude the following: names; postal address information; telephone numbers; fax numbers; electronic mail addresses; Social Security numbers; medical record numbers; health plan beneficiary numbers; account numbers; certificate/license numbers; vehicle identifiers and serial numbers, including license plate numbers; device identifiers and serial numbers; web universal resource locators (URL's); internet protocol, (IP) address numbers; biometric identifiers, including finger and voice print; and full face photographic images and any comparable images. It will be expressly recognized, however, to the extent additional identifiers are specified the same will be incorporated as part of such de-identification step 70.

With respect to the performance of such de-identification step 70, it is contemplated that the same may be achieved by a variety of methods known in the art. Specifically, it is contemplated that the EMR software provided in step 30 may be operative to delete any and all identifiers prohibited by HIPAA. Software operative to remove such specific identifiers can be readily designed by one having ordinary skill in the art. Alternatively, such de-identification of data can be accomplished by editing via conventional editorial practices, such as through word processing or by simply redacting any and all applicable identifier information. In any event, however, it is expressly contemplated that step 70 will be performed with the utmost attention that the de-identification of data is conducted with the utmost care to ensure compliance with HIPAA. To that end, it is contemplated that such de-identification of data conducted via step 70 may be performed by either the healthcare provider pursuant to an internal policy regarding the generation and use of de-identified data and limited data sets or through one or more entities appointed by the healthcare provider that are properly certified to de-identify such data.

In any event, once such information has been sufficiently de-identified so that the same no longer includes the patient information sought to be maintained in a secure and private manner, such data will be forwarded to a certified recipient in step 80. With respect to the latter, it is contemplated that such certified recipient will be set forth in the research/data use agreement with which the healthcare provider had entered into in step 40. Such certified recipient, which may take the form of any person or entity who is legally authorized to receive such data, may thereafter use the data for all legal purposes. Along these lines, it is expressly contemplated that the data which may be forwarded to such certified recipient will be expressly governed by the research/data use agreement and may provide for the generation of revenue from either the certified recipient to the healthcare provider, the certified recipient to the licensee of the EMR software/hardware, between the certified recipient, and or any other third party responsible for implementing the systems and methods specified herein. Accordingly, all potential transactions related to the generation and use of such data pursuant to the methodology disclosed herein is expressly contemplated to fall within the scope of the present invention.

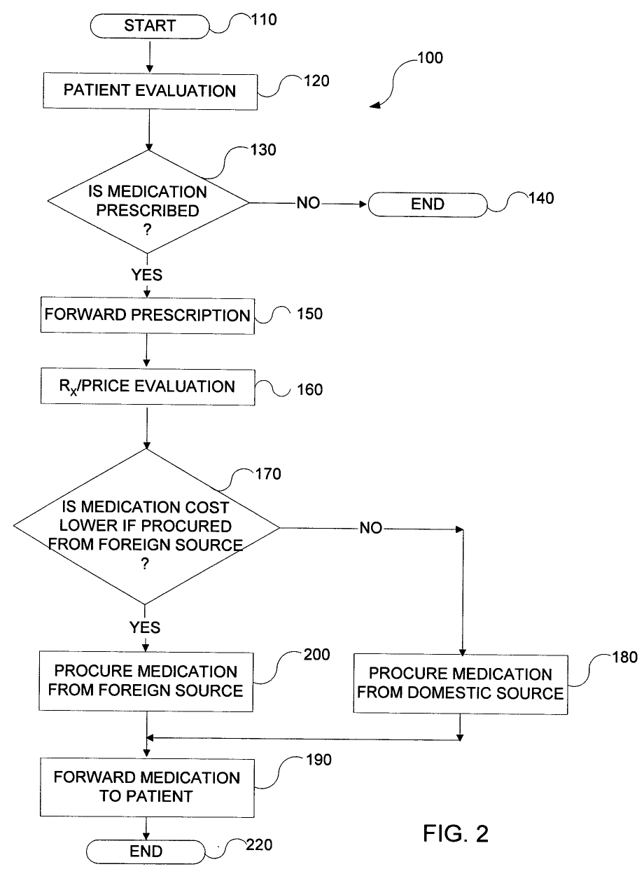

Referring now to FIG. 2, there is shown a further process 100 of the present invention that may be integrated as part of such EMR data compilation methodology that can be utilized to provide prescription medications to patients treated by a particular healthcare provider. It is expressly contemplated, however, that while the process 100 is particularly well-suited for integration within the data compilation systems and processes discussed above with respect to FIG. 1, such pharmaceutical distribution practices discussed herebelow may serve as a separate and independent model through which pharmaceuticals may be dispensed directly to patients in a manner that is substantially more efficient and cost-effective that prior art practices.

Such pharmaceutical distribution practices start 110 via conventional healthcare practices whereby a patient undergoes conventional patient evaluation via step 120. Such patient evaluation will typically be in the form of an office visit or other clinical setting where a particular patient is assessed and properly diagnosed. As part of such evaluation 120, the healthcare provider will determine via step 130 whether or not a particular medication is to be prescribed. To the extent no medication is prescribed, the process ends 140.

On the other hand, to the extent a medication is prescribed, such prescription is forwarded via step 150 to a prescription benefit entity, which may comprise a pharmaceutical distribution management company, healthcare plan, health maintenance organization, retail pharmacy, mail order pharmaceutical distribution company, or any entity capable of filling prescriptions as per conventional practices. Upon receipt of such prescription, the same is evaluated 160 both clinically and for price. With respect to the former, it is expressly contemplated that the procedures of the present invention will preferably integrate as a part thereof all applicable safeguards to ensure that the medication prescribed is objectively reasonable, and will not otherwise produce an adverse reaction. For example, it is expressly contemplated that the prescription evaluation step 160 will take into consideration any and all potential drug interactions, existing conditions of the patient, potential contraindications, any allergies that the patient may possess, and any other pertinent factors that must be taken into consideration to ensure that the medication prescribed will not adversely affect the patient. Such safeguards, which are well-known to those skilled in the art, can be integrated as part of such prescription evaluation 160 utilizing known technology and medical data bases that are operative to provide warnings or restrict the distribution of pharmaceuticals to the extent a specific medication that is prescribed is known or suspected to bring about an unfavorable reaction in a particular patient.

In addition to the clinical suitability of the prescription, the prescription is further evaluated to determine where such prescription may be filled at the lowest possible price. In determining such issue, an express consideration will be made via step 170 as to whether the cost of the medication prescribed is lower if procured from a foreign source, namely, a source within a country outside the United States, as compared to a domestic source. Upon evaluating whether or not the medication prescribed is not less expensive if procured from a foreign source, the medication is procured from a domestic source 180. As will be appreciated by those skilled in the art, such medication may be procured from any conventional source well-known to those skilled in the art. Once procured from such domestic source, the same is forwarded to the patient via step 190. With respect to the latter, it will be understood that such medication may be provided to the patient via any conventional distribution method known or later developed, whether it be a retail pharmacy or any other known outlet. Along these lines, it is presently contemplated that the use of mail order to distribute or forward such medication to the patient via step 190 will be particularly effective given the low overhead associated with such distribution practices.

In the alternative, to the extent a particular medication is, in fact, less expensive than if procured domestically, the medication sought to be prescribed is procured from a foreign source via step 200. Along these lines, it is expressly contemplated that such medication may be imported into this country pursuant to all legal laws and regulations, particularly with respect to the importation of pharmaceuticals set forth in H.R. 4461, signed into law by President Clinton on Oct. 28, 2000. According to such legislation, importation is allowed for personal use of a patient. To achieve that end, it is expressly contemplated that medication will be procured from a foreign source pursuant to a valid prescription having the name and phone number of the healthcare provider, that the amounts of the prescription medication will only be for personal consumption of the patient, which presently will not exceed a maximum of three months supply of the particular medication. Moreover, it will be expressly understood that any medication procured from a foreign source will be expressly include certifying documentation that such order is for the patient's personal consumption.

Once procured from such foreign source via step 200, the same is forwarded to the patient via step 190, as discussed above. Thereafter, once the patient is in receipt of the medication, the process ends 220.

Although it is expressly contemplated that the process 100 discussed above will be particularly well suited for the ongoing distribution of medications utilized to treat chronic conditions, such as arthritis and hypertension, the same may none the less be utilized to distribute medications to treat acute conditions, such as infections. Moreover, while it is expressly contemplated that mail order will be best suited to facilitate the distribution of such medications, it is expressly contemplated that any and all distribution systems, whether it be retail pharmacies and the like, can readily implement the methodology of the present invention. Furthermore, it is expressly contemplated that to the extent a particular prescription may be filled pursuant to the methodology of the present invention, it is contemplated that medical data generated in step 50 set forth in FIG. 1 (in addition to data that may be compiled in step 150 of FIG. 2) can, in fact, include prescribing information that can be transmitted, in accordance with HIPAA, to thus ensure that such prescription is filled in connection with the methodology set forth above with respect to process 100, as well as the use of data associated therewith as per process 10.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

1. A method for collecting medical data regarding at least one patient for use in generating and maintaining confidential medical records related said at least one patient and information useful for research purposes, the method comprising the steps:
a) generating confidential medical information related to said at least one patient, said confidential medical information being obtained by a healthcare provider;
b) entering into a research agreement with said healthcare provider, said healthcare provider being obligated pursuant to the terms of such agreement to provide a portion of the information generated in step (a);
c) editing said confidential information generated in step (a) such that said information becomes de-identified; and
d) providing said de-identified information generated in step (c) to a recipient, said recipient being authorized to receive data pursuant to said research agreement entered into in step (b).

2. The method of claim 1 wherein in step (a), said confidential medical information is collected utilizing electronic medical record software.

3. The method of claim 2 wherein prior to step (a), said method comprises the steps:
a) providing said healthcare provider with electronic medical record software operative to receive, store, retrieve, and transmit medical information related to said at least one patient.

4. The method of claim 3 wherein said step of providing said healthcare provider with said electronic medical records software further comprises entering into a transaction with said healthcare provider to allow said healthcare provider access to utilize said electronic medical records software.

5. The method of claim 1 wherein steps (a)-(d) are repeated on a routine basis.

6. The method of claim 5 wherein steps (a)-(d) are repeated at least once per day.

7. The method of claim 5 wherein steps (a)-(d) are repeated at least once per week.

8. The method of claim 1 wherein step (c) comprises editing said confidential information such that all identifiers related to said at least one patient are removed therefrom.

9. The method of claim 8 wherein said identifiers removed from said confidential medical information include information selected from the group consisting of said at least one patient's name, said at least one patient's postal address information, said at least one patient's telephone number, said at least one patient's Social Security number, said at least one patient's medical record numbers, said at least one patient's health plan beneficiary numbers, said at least one patient's biometric identifiers, and images of said at least one patient.

10. The method of claim 1 wherein step (c) comprises de-identifying said information in compliance with the Health Insurance Portability and Accountability Act of 1996.

11. The method of claim 10 wherein said de-identification of data pursuant to the Health Insurance Portability and Accountability Act of 1996 generates a limited data set as defined by the Health Insurance Portability and Accountability Act of 1996.

12. The method of claim 1 wherein in step (b), said agreement specifies that said use of said portion of said data provided by said healthcare provider is for public health.

13. The method of claim 1 wherein in step (b), said agreement specifies that said use of said portion of said data provided by said healthcare provider is for healthcare operations.

14. The method of claim 3 wherein computer hardware operative to be utilized in connection with said electronic medical records software is also provided to said healthcare provider.

15. The method of claim 1 wherein in step (a), said medical information compiled by said healthcare provider is stored in an electronic format in compliance with the Health Insurance Portability and Accountability Act of 1996.

16. The method of claim 1 wherein step (a) further comprises generating information related to the use of prescription medications by said at least one patient, and utilizing a pharmaceutical distribution method for use in supplying medications to said at least one patient, said pharmaceutical distribution method comprising the steps:
a) determining and confirming said at least one patient is in need of a prescription medication and generating a prescription for said at least one patient to obtain said medication;
b) determining the lowest cost for which said medication prescribed in step (a) can be procured by said at least one patient, said determination comprising comparing the purchase price for said medication based upon procuring said medication from a source from within the United States, to the purchase price for said medication based upon procuring said medication from a source outside of the United States;
c) procuring the lowest-cost medication identified in step (b);
d) forwarding said medication procured in step (d) to said patient.

17. The method of claim 16 wherein step (d) of said pharmaceutical distribution method comprises forwarding said medication via mail order.

18. The method of claim 16 wherein step (a) of said pharmaceutical distribution method further comprises clinically evaluating said prescription to minimizes averse reactions potentially experienced by said at least one patient.
